(19) United States
(12) Patent Application Publication
(10) Pub. No.: US 2026/0172899 A1
(43) Pub. Date: Jun. 18, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: YUKI YOSHIKAWA, Kanagawa (JP)

(21) Appl. No.: 19/532,713

(22) Filed: Feb. 6, 2026

Related U.S. Application Data
(63) Continuation of application No. PCT/JP2024/027915, filed on Aug. 5, 2024.

(30) Foreign Application Priority Data
Aug. 10, 2023 (JP) 2023-131392

(51) Int. Cl. H04W 28/06; H04L 1/00

(52) U.S. Cl. CPC H04W 28/065; H04L 1/0003

(57) ABSTRACT

A communication apparatus includes at least one memory that stores a set of instructions, and at least one processor that executes the instructions, the instructions, when executed, causing the communication apparatus to perform operations including performing control to generate an Aggregated media access control (MAC) Protocol Data Unit (A-MPDU) in which a plurality of MAC frames each including a MAC header and payload is bundled and to transmit the generated A-MPDU, wherein the communication apparatus is configured to, in a case where a specific condition is satisfied, perform control to transmit an A-MPDU in which a plurality of MAC frames destined for a plurality of different destinations is bundled, the plurality of MAC frames including at least a first MAC frame destined for a first destination and a second MAC frame destined for a second destination.

### CROSS-REFERENCE TO RELATED APPLICATIONS

This application is a Continuation of International Patent Application No. PCT/JP2024/027915, filed Aug. 5, 2024, which claims the benefit of Japanese Patent Application No. 2023-131392, filed Aug. 10, 2023, both of which are hereby incorporated by reference herein in their entirety.

### BACKGROUND

### Field of the Technology

The present disclosure relates to a communication apparatus that performs wireless communication.

### Description of the Related Art

The Institute of Electrical and Electronics Engineers (IEEE) 802.11 standards are known as communication standards related to wireless local area networks (LANs). In the IEEE 802.11be standard and its successor standards, improving communication efficiency and throughput by coordinated operation of a plurality of access point apparatuses (hereinafter, also referred to simply as access points [APs]) has been studied.

United States Patent Application Publication No. 2022/0070772 describes a technique called Restricted Target Wake Time (R-TWT), which provides a period available to communicate data for which low delay is required and communicates such data in that period.

The foregoing R-TWT technique can reduce latency when transmitting regularly occurring data in scheduled periods.

Data for which low delay is required may also occur outside the foregoing scheduled periods. To transmit such data with low delay, prioritized communication needs to be implemented using a technique different from R-TWT.

### SUMMARY

This disclosure has been made in view of at least one of the above-described issues. The present disclosure is directed to providing a mechanism for transmitting data of higher priority for another destination by interrupting frames containing data for a given destination.

According to an aspect of the present disclosure, a communication apparatus includes at least one memory that stores a set of instructions, and at least one processor that executes the instructions, the instructions, when executed, causing the communication apparatus to perform operations including performing control to generate an Aggregated media access control (MAC) Protocol Data Unit (A-MPDU) in which a plurality of MAC frames each including a MAC header and payload is bundled and to transmit the generated A-MPDU, wherein the communication apparatus is configured to, in a case where a specific condition is satisfied, perform control to transmit an A-MPDU in which a plurality of MAC frames destined for a plurality of different destinations is bundled, the plurality of MAC frames including at least a first MAC frame destined for a first destination and a second MAC frame destined for a second destination.

Features of the present disclosure will become apparent from the following description of embodiments with reference to the attached drawings.

### BRIEF DESCRIPTION OF THE DRAWINGS

FIG. 1 is a diagram illustrating an example of a configuration of a network system.

FIG. 2 is a diagram illustrating an example of a hardware configuration of a communication apparatus (access point [AP]/station [STA]).

FIG. 3 is a diagram illustrating an example of a software configuration of the communication apparatus (AP/STA).

FIG. 4 is a flowchart illustrating an example of communication control by the AP.

FIG. 5 is a flowchart illustrating an example of communication control by an STA.

FIG. 6 is a schematic diagram illustrating an example of capability information communicated between apparatuses.

FIG. 7 is a schematic diagram illustrating an example of a physical layer protocol data unit (PPDU) that enables low-latency data interrupt communication.

FIG. 8 is a sequence diagram illustrating an example of communication exchange between the AP and STAs.

FIG. 9 is a schematic diagram illustrating an example of a procedure for data communication between the AP and the STAs.

FIG. 10A illustrates an example of an Emergency Request frame communicated in a second embodiment. FIG. 10B illustrates an example of an Emergency Response frame communicated in the second embodiment.

FIG. 11 is a schematic diagram illustrating a modification of the PPDU that enables interrupt communication.

### DESCRIPTION OF THE EMBODIMENTS

Embodiments will be described in detail below with reference to the attached drawings. The following embodiments are not intended to limit the disclosure set forth in the claims. While a plurality of features is described in the embodiments, not all these features are necessarily essential to the disclosure, and multiple features may be freely combined. In the attached drawings, identical or similar components are denoted by the same reference numerals, and redundant descriptions thereof will be omitted.

### First Embodiment

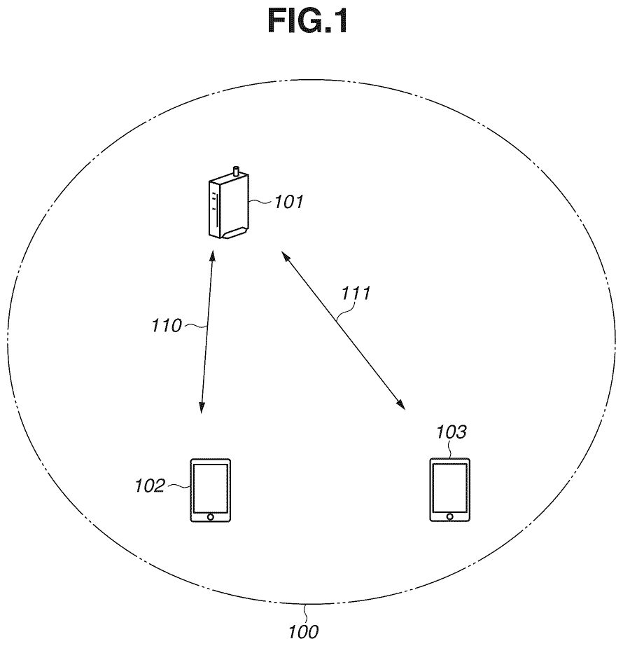

FIG. 1 illustrates a configuration example of a network system according to the present embodiment. This network system includes an access point apparatus (hereinafter, also referred to simply as an AP, an AP STA, or an access point) and two station apparatuses (hereinafter, also referred to simply as STAs, Non-AP STAs, or stations). An AP 101 and STAs 102 and 103 may hereinafter be referred to collectively as communication apparatuses.

The AP 101 is configured to be capable of performing wireless frame communication compliant with the Institute of Electrical and Electronics Engineers (IEEE) 802.11bn standard, which is a successor standard to the IEEE 802.11be targeting a maximum transmission rate of 46.08 Gbps. The STAs 102 and 103 are also configured to be capable of performing wireless frame communication compliant with the successor standard. FIG. 1 illustrates data communications 110 and 111 between the communication apparatuses.

IEEE 802.11bn, which is a successor standard to IEEE 802.11be, features high-reliability communication, low-latency communication, and improved throughput during congestion as its primary characteristics. Wireless frames communicated by this successor standard will also be referred to as Ultra High Reliability (UHR) physical layer protocol data units (PPDUs).

The names IEEE 802.11bn and UHR standards are provisional ones for convenience in view of the goals to be achieved by the successor standard and key features of the standard, and different names may be assumed upon completion of standardization. Meanwhile, it should be noted that this specification and the appended claims are essentially applicable to all successor standards to the IEEE 802.11be standard.

While FIG. 1 illustrates a wireless communication network including one AP and two STAs as an example, the numbers of such apparatuses may be greater than or fewer than illustrated. Moreover, while the AP 101 and the STAs 102 and 103 are described to support UHR PPDU communication (transmission and reception) of the IEEE 802.11bn standard, this is not restrictive. The communication apparatuses may be configured to support PPDU communication of legacy standards preceding the IEEE 802.11bn standard as well. Specifically, the AP 101 and the STAs 102 and 103 can also be configured to support PPDU transmission and reception of the IEEE 802.11a/b/g/n/ac/ax/be standards and the like.

The AP 101 provides the network 100 for the STAs 102 and 103. The STAs 102 and 103 are STAs that join the network 100 provided by the AP 101. FIG. 1 illustrates a case where the STAs 102 and 103 have joined the network 100 provided by the AP 101.

The AP 101 and the STAs 102 and 103 may be configured to support wireless communication based on other communication standards such as Bluetooth®, near-field communication (NFC), and Bluetooth® Low Energy.

The AP 101 can also be configured to support wired communication using Ethernet cables and/or wired communication using optical fibers. In the present embodiment, the AP 101 is assumed to be connected to the Internet via an Ethernet cable. Specific examples of the AP 101 and the STAs 102 and 103 include, but are not limited to, wireless local area network (LAN) routers and personal computers (PCs). The AP 101 and the STAs 102 and 103 may be information processing devices such as wireless chips that support UHR PPDU transmission and reception. Specific examples of the STAs 102 and 103 may include, but are not limited to, cameras, tablets, smartphones, PCs, mobile phones, video cameras, projectors, and wearable devices such as smart glasses.

The communication apparatuses such as the AP 101 and the STAs 102 and 103 can communicate at frequencies in the 2.4-, 3.6-, 5-, and 6-GHz bands, as well as the 45- and 60-GHz millimeter wave bands. The frequency bands used by the communication apparatuses are not limited thereto, and other frequency bands such as the Sub-1 GHz band may be used. The AP 101 and the STAs 102 and 103 can communicate using bandwidths of 20, 40, 80, 160, 320, 540, 640, 1080, and 2160 MHz. The bandwidths used by the communication apparatuses are not limited thereto. For example, other bandwidths such as 240 MHz and 4 MHz may be used.

Demand for low-latency communication has been increasing even in wireless communication in recent years.

For example, the IEEE 802.11be standard introduces a function called Restricted Target Wake Time (R-TWT), which provides a period available for communication where low delay is required, to meet the demand for low-latency communication. The R-TWT function can reduce latency when transmitting regularly occurring data in scheduled periods. Meanwhile, data for which low delay is required may also occur outside the foregoing scheduled periods. To transmit such data with low delay, prioritized low-latency transmission needs to be implemented using techniques other than R-TWT.

The present embodiment provides a mechanism for transmitting data of higher priority for another destination by interrupting frames containing data for a given destination. A specific description will now be described.

### Device Configuration

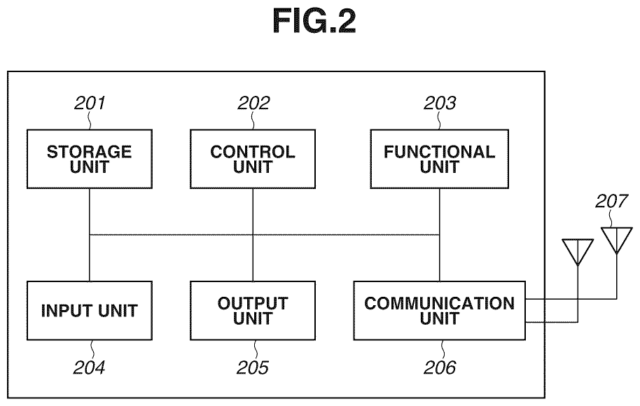

FIG. 2 illustrates a hardware configuration example of the communication apparatuses (AP 101 and STAs 102 and 103). The communication apparatuses each include, as an example of their hardware configuration, a storage unit 201, a control unit 202, a functional unit 203, an input unit 204, an output unit 205, a communication unit 206, and antennas 207. In the present embodiment, the communication apparatuses are assumed to include a plurality of antennas 207, whereas the number of antennas 207 may be one.

The storage unit 201 includes both or either one of a read-only memory (ROM) and a random access memory (RAM), and stores programs for performing various operations to be described below and various types of information such as communication parameters for wireless communication. Aside from memories such as ROM and RAM, storage media such as nonvolatile storage devices including a hard disk and a solid-state drive (SSD) may be used as the storage unit 201.

The control unit 202 includes a processor such as a central processing unit (CPU) and a microprocessing unit (MPU), an application-specific integrated circuit (ASIC), a digital signal processor (DSP), a field-programmable gate array (FPGA), or the like, for example. The control unit 202 controls the entire apparatus by executing the programs stored in the storage unit 201 and operating hardware circuits such as an ASIC. The control unit 202 may control the entire apparatus through cooperation of the programs stored in the storage unit 201 and an operating system (OS).

The control unit 202 controls the functional unit 203 to perform predetermined processing such as imaging, printing, and projection. The functional unit 203 is hardware for the communication apparatus to perform predetermined processing. For example, if the communication apparatus is a camera such as a digital still camera or a smartphone with a camera, the functional unit 203 is an imaging unit, and performs processing for capturing images of the surroundings via a not-illustrated camera unit included in the communication apparatus. If, for example, the communication apparatus is a printer, the functional unit 203 is a printing unit and performs print processing on sheets such as sheets of paper based on print data that is obtained from the outside by wireless communication. If, for example, the communication apparatus is a projector or smart glasses, the functional unit 203 is a projection unit, and performs processing for projecting image data or video data that is obtained from the outside by wireless communication. In the case of smart glasses, the projection planes are the end user's retinas or the like. The functional unit 203 may process data stored in the storage unit 201 or data obtained through communication with another AP or STA via the communication unit 206 to be described below.

The input unit 204 accepts various operations from the user. The output unit 205 provides various outputs to the user. Examples of the output from the output unit 205 include at least one of the following: screen display, audio output from a speaker, and vibration output. The input unit 204 and the output unit 205 may both be implemented by a single module like a touchscreen.

The communication unit 206 controls wireless communication compliant with the IEEE 802.11 standard series. In the present embodiment, the communication unit 206 can transmit and receive UHR PPDUs, which are wireless frames of the IEEE 802.11bn standard, and PPDUs corresponding to earlier standards in cooperation with the antennas 207. The antennas 207 are ones capable of transmitting and receiving signals in at least one of the sub-GHz, 2.4-GHz, 5-GHz, 6-GHz, 7-GHz, and 60-GHz bands, for example.

If the communication apparatus supports the foregoing NFC standard, Bluetooth® standard, wired LAN network, and the like, the communication unit 206 can be configured to control wireless communication and/or wired communication compliant with such communication standards.

### Functional Configuration

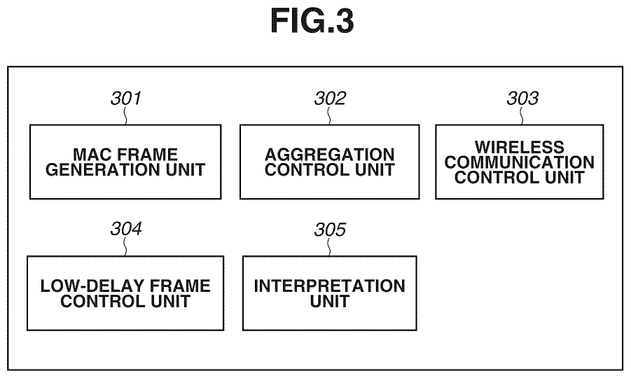

Next, the functional configurations of the communication apparatuses (AP 101 and STAs 102 and 103) will be described with reference to FIG. 3. FIG. 3 is a block diagram for describing the functional configuration of the AP 101.

The communication apparatus includes a media access control (MAC) frame generation unit 301, an aggregation control unit 302, a wireless communication control unit 303, a low-delay frame control unit 304, and an interpretation unit 305.

Each function will be described. The MAC frame generation unit 301 of the AP 101 generates MAC frames for the STAs 102 and 103. Specifically, the MAC frame generation unit 301 generates MAC frames such as data frames containing data to be transmitted to the STAs 102 and 103 and management frames to be notified to the STAs 102 and 103.

The aggregation control unit 302 performs Aggregated MAC protocol data unit (A-MPDU) generation control and transmission control in cooperation with various units including the low-delay frame control unit 304, the wireless communication control unit 303, the communication unit 206, and the antennas 207. Specifically, to transmit MAC frames generated by the MAC frame generation unit 301 to the outside, the aggregation control unit 302 controls communication so that a plurality of MAC frames is aggregated into one A-MPDU and transmitted to the outside. An A-MPDU refers to a PPDU consisting on a physical layer (PHY) preamble and a data portion in which multiple MAC frames are concatenated and stored.

The aggregation control unit 302 also has a function of rescheduling frames scheduled for transmission to transmit low-latency data in an interrupting manner based on interrupt instructions received from other functional units.

Receiving instructions for data transmission and data to be transmitted from the aggregation control unit 302, the wireless communication control unit 303 generates a signal representing a UHR PPDU where MAC frames are aggregated in the A-MPDU format and transmits the signal to the outside in cooperation with the communication unit 206 and the antennas 207. The wireless communication control unit 303 also controls reception of frames transmitted from other communication apparatuses in cooperation with the communication unit 206 and the antennas 207. The configuration of the UHR PPDU for the AP 101 to transmit will be described below. The frames received by the wireless communication control unit 303 are decoded by the interpretation unit 305 as appropriate. The interpretation unit 305, when a received frame is interpreted and determined to be a data frame destined for itself, extracts the data included in the payload and transfers the data to not-illustrated upper layers (such as the Internet Protocol [IP] layer). When a receive frame is interpreted as a management frame destined for itself, the interpretation unit 305 performs communication control in cooperation with various units based on the decoding result of the frame.

The low-delay frame control unit 304, during execution of processing for generating and transmitting an A-MPDU containing data for a given STA, detects occurrence of low-latency data to be transmitted to another STA. The low-delay frame control unit 304 also performs control to transmit the detected low-latency data in an interrupting manner in cooperation with various units. Specifically, the low-delay frame control unit 304 transmits to the MAC frame generation unit 301 an interrupt instruction that includes information specifying the destination of MAC frames and the storage address of the interrupting data. Receiving the interrupt instruction, the MAC frame generation unit 301 generates the MAC frames to be transmitted by interrupting the A-MPDU, based on the specifying information. The MAC frame generation unit 301 then transmits to the aggregation control unit 302 information about the MAC frames and an instruction that triggers rescheduling of the transmission order. Receiving the information and the instruction that triggers rescheduling, the aggregation control unit 302 reschedules the group of frames scheduled for transmission. When the data order is changed by rescheduling, the aggregation control unit 302 notifies the wireless communication control unit 303 of transmission instructions and the data order so that the MAC frames are transmitted in the rescheduled order. For example, consider a case where signals corresponding to MAC frames 1 and 2 destined for destination 1 have been generated and transmitted, and the subsequent MAC frame 3 is buffered and scheduled for transmission. In such a case, the low-delay frame control unit 304 schedules the transmission order so that MAC frame 4 destined for destination 2 to be transmitted in an interrupting manner is transmitted at a reschedulable point, which is before MAC frame 3 destined for destination 1. Note that the low-delay frame control unit 304 of the AP 101 also manages information about the STAs 102 and 103 connected to the AP 101. Here, the information about the STAs 102 and 103 is managed to enable distinction of whether each STA has a function of accepting interrupt reception to be described below. This information is used to identify STAs capable of interrupt reception during control to be described below. MAC frame 1 is an example of a first MAC frame, and MAC frame 4 is an example of a second MAC frame.

Destination 1 is an example of a first destination, and destination 2 is an example of a second destination.

The STAs 102 and 103 include functional units similar to those of the AP 101. In other words, the STAs 102 and 103 can generate and transmit frames destined for the AP 101, and receive and decode frames transmitted from the AP 101, through cooperation of various units.

### Low-Latency Data Interrupt Control

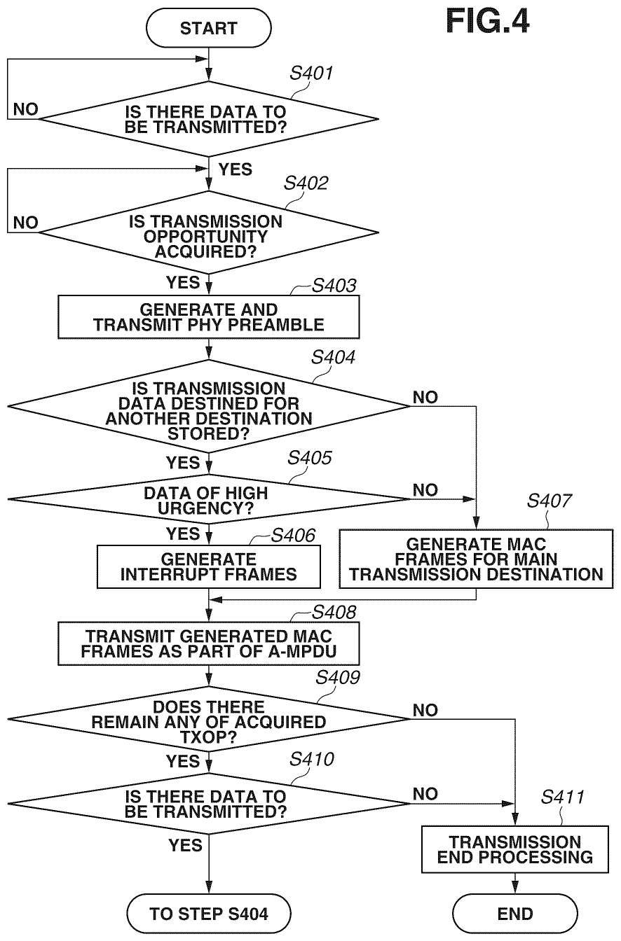

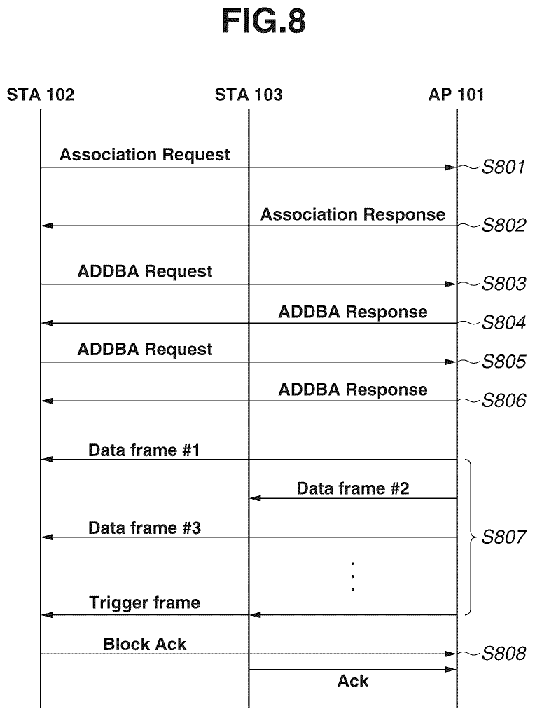

Specific interrupt processing will now be described with reference to FIGS. 4 to 9. An overall communication sequence will initially be described with reference to FIG. 8.

FIG. 8 is a sequence diagram for describing an example of a processing procedure when the AP 101 performs low-latency data interrupt processing with the STAs 102 and 103. In FIG. 8, it is assumed that the STA 103 has already established a connection with the AP 101 and is ready for data communication. In the illustrated procedure, the STA 102 establishes a new connection with the AP 101, and A-MPDU transmission to the STAs 102 and 103 is then performed.

In step S801, the STA 102 initially transmits an Association Request to establish a connection with the AP 101. STAs such as the STA 102 include, into the Association Request to be transmitted to APs such as the AP 101, an information element including capability information for notifying of the presence or absence of the capability to accept low-latency data interrupt reception.

This information element may be included in a Probe Request frame. To notify STAs of the presence or absence of the capability to perform low-latency data interrupt transmission, APs such as the AP 101 may include the information element into a Beacon frame or a Probe Response frame.

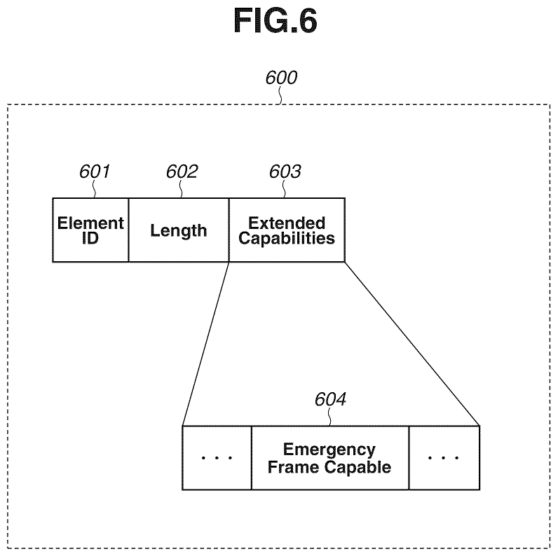

The information element including the capability information to be exchanged between the STA 102 and the AP 101 will now be described with reference to FIG. 6. FIG. 6 is a schematic diagram illustrating an example of an Extended Capabilities Element 600, which is an information element including the capability information indicating the presence of the capability to accept low-latency data interrupt reception.

The Extended Capabilities Element 600 includes an Element identifier (ID) field 601, a Length field 602, and an Extended Capabilities field 603. The Element ID field 601 stores “127”, which indicates that this element is an Extended Capabilities Element. The Length field 602 stores a value indicating the length of the Extended Capabilities Element 600.

The Extended Capabilities field 603 is a field composed of a group of bits indicating the support status of various capabilities. In the present embodiment, the Extended Capabilities field 603 includes a 1-bit Emergency Frame Capable field 604. Storing “1” in the Emergency Frame Capable field 604 indicates the presence of the capability to accept low-latency data interrupt reception or the capability to perform low-latency data interrupt transmission. Storing “0” in the Emergency Frame Capable field 604 indicates the absence of the capability to accept low-latency data interrupt reception or the capability to perform low-latency data interrupt transmission.

In the present embodiment, as an example, the Extended Capability Element 600 is described to indicate the presence or absence of the capability to accept low-latency data interrupt reception or the capability to perform low-latency data interrupt transmission. However, the method of indication is not limited thereto. For example, a new information element for indicating the capabilities of a UHR non-AP STA or UHR AP STA may be defined. In such a case, this information element may be configured to include the foregoing Emergency Frame Capable field 604 so that the presence or absence of the capability is indicated by this field.

Moreover, if UHR AP STAs and UHR non-AP STAs mandatorily support the foregoing capability to accept low-latency data interrupt reception or perform low-latency data interrupt transmission, the capability notification may be omitted. In such a case, a communication apparatus may be assumed to have the capability to accept low-latency data interrupt reception or perform low-latency data interrupt transmission, based on being an STA/AP supporting UHR PPDUs. Using such frames or the foregoing assumption, the foregoing low-delay frame control unit 304 manages STAs assumed to have the capability to accept low-latency data interrupt reception distinguishably from ones assumed to not have the capability.

Return to the description of FIG. 8. In step S802, receiving the Association Request from the STA 102, the AP 101 transmits an Association Response to the STA 102. As described above, the information element indicating the presence or absence of the capability to perform low-latency data interrupt transmission can be included in the Association Response. The AP 101 according to the present embodiment controls transmission of an Association Response including the information element indicating the presence of the capability to perform low-latency data interrupt transmission.

Through the processing of steps S801 and S802, the STA 102 establishes a connection with the AP 101. Here, 4-way handshake or other procedures can be performed to generate keys for use in subsequent encrypted communication.

Next, data communication will be described that follows the execution of the connection establishment processing and, when needed, the processing for encrypted communication.

In steps S803 to S806, for A-MPDU transmission and reception, the AP 101 and the STA 102 transmit and receive an Add Block Acknowledgment (ADDBA) Request and an ADDBA Response to/from each other. The completion of this transmission and reception enables transmission and reception of an A-MPDU including a plurality of frames concatenated. The presence or absence of the capability to accept low-latency data interrupt reception and the capability to perform low-latency data interrupt transmission may also be indicated in the ADDBA Request/Response.

In step S807, the AP 101 transmits the A-MPDU for the STAs 102 and 103. FIG. 8 illustrates a case where, after a MAC frame destined for the STA 102, a MAC frame destined for the STA 103 is transmitted in an interrupting manner, and then MAC frames destined for the STA 102 of which the transmission order is deferred as a result of the interrupt are transmitted. To receive Acks from the STAs 102 and 103, the AP 101 also transmits a Trigger frame. In step S808, receiving the Trigger frame, the STAs 102 and 103 transmit acknowledgment responses to the AP 101. Through the procedure described above, the AP 101 and the STAs 102 and 103 can exchange data using an A-Mpdu including interrupt data.

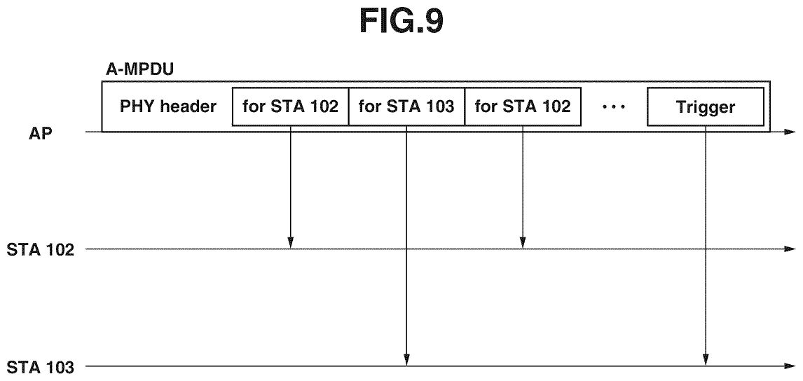

Next, the frame transmission illustrated in step S807 of FIG. 8 will be further described with reference to FIG. 9. FIG. 9 is a schematic diagram illustrating an example of a procedure for data communication between the AP 101 and the STAs 102 and 103. As illustrated in FIG. 9, the AP 101 transmits to the outside a single UHR PPDU in which a plurality of MAC frames is bundled in A-MPDU format. The MAC frames each have a field indicating their destination address. The first and third MAC frames contain the MAC address of the STA 102, which is the main destination. The second MAC frame contains the MAC address of another STA 103, which is the destination of the low-latency data.

The interpretation units 305 of the STAs 102 and 103 interpret the MAC frames included in the received PPDU as appropriate, and interpret and process MAC frames destined for itself. The Trigger frame included at the end of the PPDU is transmitted to both the STAs 102 and 103. The Trigger frame is thus received and interpreted by both the STAs 102 and 103 as appropriate. As a result of the interpretation, the STAs 102 and 103 can transmit acknowledgment responses indicating the data reception status.

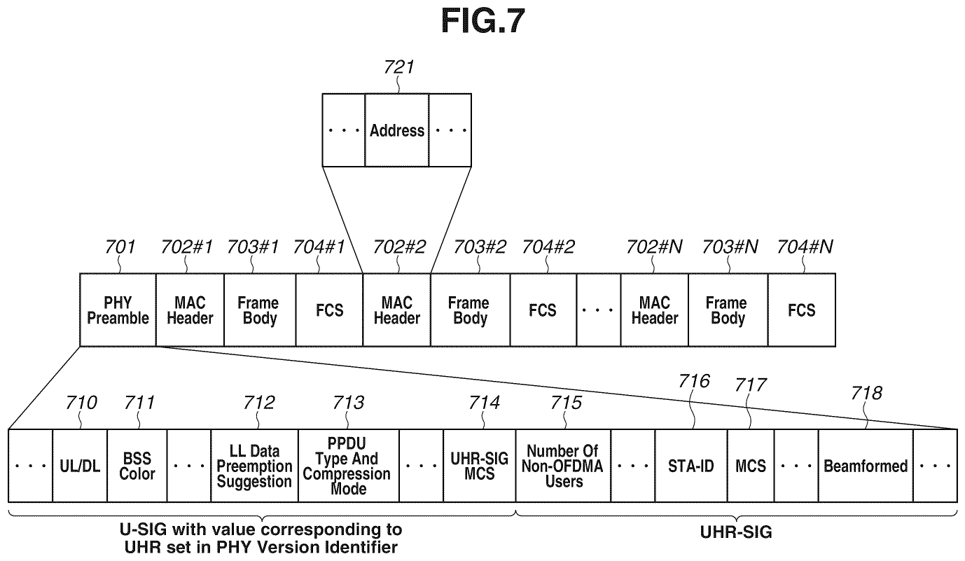

A more detailed format of the UHR PPDU that the AP 101 transmits to the STA 102 will be described with reference to FIG. 7. FIG. 7 is a schematic diagram for describing the format of the UHR PPDU that the AP 101 transmits to the STAs 102 and 103. The UHR PPDU that is the A-MPDU transmitted by the AP 101 in step S807 consists of a PHY preamble 701 and a data portion. The data portion includes a plurality of MAC frames.

The PHY preamble 701 includes training fields for timing, frequency, and channel estimation at the physical layer, and SIGNAL fields indicating information needed for the reception of the data portion. A Non-High Throughput (HT) Short Training field (Legacy Short Training field [L-STF]), a Non-HT Long Training field (Legacy Long Training field [L-LTF]), a Non-HT SIGNAL (Legacy SIGNAL [L-SIG]) field, and a Repeated Non-HT SIGNAL (Repeated Legacy SIGNAL [RL-SIG]) field are included in order from the beginning. These fields are followed by a Universal SIGNAL (U-SIG) field and a UHR SIGNAL (UHR-SIG) field. The first three bits of the U-SIG constitute a not-illustrated PHY Version Identifier field, which stores a value indicating UHR. This value can be “1”, for example. The UHR-SIG is followed by a UHR-STF and a UHR-LTF to be used for timing and frequency synchronization and channel estimation.

The U-SIG and UHR-SIG store information needed to decode the UHR PPDU. Fields closely related to the present disclosure will be briefly described. The U-SIG includes an Uplink/Downlink (UL/DL) field 710, a Basic Service Set (BSS) Color field 711, a Low-Latency (LL) Data Preemption Suggestion Field 712, a PPDU Type And Compression Mode field 712, a UHR-SIG Modulation and Coding Scheme (MCS) field 714, and a Number Of Non-orthogonal frequency division multiple access (OFDMA) Users field 715. The UHR-SIG includes an STA-ID field 716, an MCS field 717, and a Beamformed field 718.

The UL/DL field 710 indicates whether the frame is for UL or DL. When the AP 101 transmits data, the communication is DL regardless of whether multiple MAC frames are included. The AP 101 thus stores “0” in this field. The BSS Color field 711 stores BSS coloring information for specifying which AP provides the network for which the PPDU is destined. The AP 101 sets its own BSS color value to not overlap with those of APs nearby. The AP 101 then sets the BSS color value set for itself into the BSS Color field 711. The value of this BSS Color field 711 is used by the STAs that receive the PPDU to determine whether the PPDU is destined for the network to which the STAs themselves belong or for another network. This determination is implemented by the STAs such as the STAs 102 and 103 storing the BSS color value of the network they belong to, and comparing the BSS color value included in the received PPDU with the BSS color value stored in themselves.

The LL Data Preemption Suggestion field 712 is a field indicating whether an interrupt by a low-latency data MAC frame may occur.

Storing “1” in this field indicates that an interrupt by a low-latency data MAC frame may occur. Storing “0” in this field indicates not. This information is used for the STAs 102 and 103 to determine whether to stand by for low-latency data interrupt reception.

The PPDU Type And Compression Mode field 713 indicates a PPDU type. In the present embodiment, the AP 101 sets “1” in this field. According to the IEEE 802.11be standard, “3” in this field means a reserved value. This reserved value can also be used as a value for notifying STAs whether an interrupt by a low-latency data MAC frame may occur. In such a case, the AP 101 sets “3” in the PPDU Type And Compression Mode field 713 to indicate that this PPDU may be interrupted, instead of including the LL Data Preemption Suggestion field 712 in the U-SIG. In such a manner, the U-SIG can be configured to indicate that an interrupt by a low-latency data MAC frame may occur in the PPDU by setting “3” in the PPDU Type And Compression Mode field 713. In such a case, the STAs 102 and 103 refer to the value of the PPDU Type And Compression Mode field 713 and determines whether to stand by for low-latency data interrupt reception.

The UHR-SIG MSC field 714 defines an MSC that indicates the modulation scheme and coding rate of the UHR-SIG. The value of the UHR-SIG MSC field 714 is information needed to interpret the subsequent UHR-SIG. The UHR-SIG will now be described. The Number Of Non-OFDMA Users field 715 sets the number of users in simultaneous communication when simultaneously transmitting frames to multiple STAs using Multi-User Multiple Input Multiple Output (MU-MIMO) frames. In the present embodiment, the antennas 207 are operated as omni antennas to nondirectionally transmit signals constituting the A-MPDU without using techniques such as MIMO and beamforming, so that a plurality of STAs in different positional relationships can transmit A-MPDU data. For such a reason, “1” is set in the Number Of Non-OFDMA Users field 715. The UHR-SIG then includes one or more user fields containing information for PPDU destination users. In the present embodiment, a user field for one user is provided. This field includes the STA-ID field 716, the MCS field 717, and the Beamformed field 718.

The MCS field 717 stores an MCS indicating the modulation scheme, coding rate, and other parameters of the data field, i.e., MAC frames. The value indicating the MCS is used for the STAs 102 and 103 to decode the data field. When transmitting a PPDU indicating that an interrupt by a low-latency data MAC frame may occur, the AP 101 may set an MCS value that enables data reception even at the STA with the poorest communication conditions among the STAs that can be communication partners. In other words, the AP 101 manages MCSs to be used for communication with the STAs on an STA-by-STA basis. The AP 101 then determines the MCS corresponding to the STA with the poorest communication condition among the MCSs of the STAs that can be communication partners, as the MCS of the data portion. The AP 101 then sets the determined MCS in the MCS field 717 illustrated in FIG. 7. Setting the MCS value in such a manner enables the STA located the farthest from the AP 101 to appropriately receive interrupt data.

The STA-ID field 716 stores an ID for identifying a receiving STA or an ID indicating a group of receiving STAs. In the present embodiment, the AP 101 is assumed to store “0” in the STA-ID field 716. However, this is not restrictive, and the AP 101 may be configured to store the ID of the STA that is the main transmission destination (for example, the STA-ID corresponding to the destination of the first MAC frame). Alternatively, a common Group ID may be assigned to STAs having the capability to accept low-latency data interrupt reception, such as the STAs 102 and 103, and the Group ID may be stored in the STA-ID field 716. The Beamformed field 718 indicates whether a Beamform steering matrix is used with a non-MU-MIMO allocation. In the present embodiment, to transmit non-directional signals as described above, the AP 101 sets “0” in the Beamformed field 718.

Next, the PPDU data field of the A-MPDU format will be described. The PPDU data field stores various MAC frames. Each MAC frame includes a MAC Header field 702, a Frame Body field 703, and a Frame Check Sequence (FCS) field 704. The MAC Header field 702 includes an Address field 721, in which the destination MAC address of the MAC frame is stored. The Frame Body field 703 is a frame body containing the content of the MAC frame. In the case of a data frame, the data content to be transmitted is stored in the Frame Body field 703. The FCS field 704 is a field for verification.

FIG. 7 illustrates a case where the MAC address of the STA 102 is stored in a MAC Header field 702#1, and the MAC address of the STA 103 is stored in a MAC Header field 702#2. In the illustrated example, the MAC address of the STA 102 is also stored in the subsequent MAC Header field 702#3. Suffixes such as “#1” and “#2” indicate the order of the MAC frames within the A-MPDU. The suffix “#1” indicates the first MAC frame element, and “#2” the second MAC frame element. The suffix “#N” indicates the Nth MAC frame element.

As described with reference to FIGS. 8 and 9, the MAC frame to be attached to the end of the PPDU is a Trigger frame for triggering an acknowledgment response. The AP 101 stores a broadcast address in the MAC Header field 702#N of this Trigger frame.

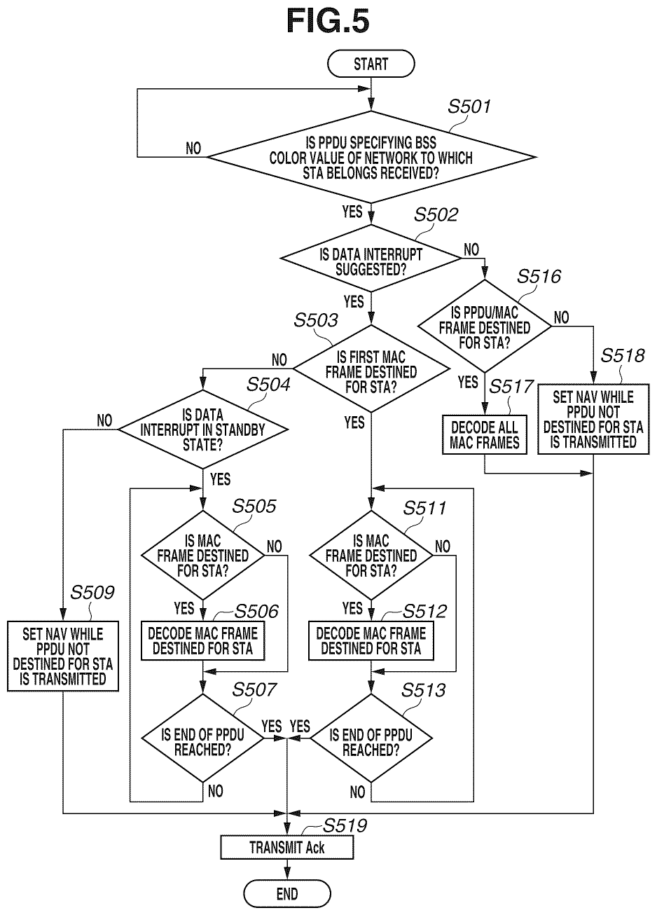

Next, interrupt transmission control performed by the AP 101 of the present embodiment will be described with reference to FIGS. 4 and 5. FIG. 4 is an excerpted flowchart of data transmission processing related to interrupt processing performed by the AP 101, which is a communication apparatus. FIG. 5 is an excerpted flowchart of data reception apparatus related to interrupt processing performed by an STA such as the STA 102 and the STA 103, which are communication apparatuses.

Each process illustrated in the flowchart of FIG. 4 is implemented by the processor of the control unit 202 of the AP 101 executing a computer program stored in the storage unit 201. Each process illustrated in the flowchart of FIG. 5 is implemented by the processor of the control unit 202 of the STA, such as the STA 102 and the STA 103, executing a computer program stored in the storage unit 201. Some of the processes such as transmission, modulation, reception, and decoding in FIGS. 4 and 5 are implemented through cooperation of the processor of the control unit 202 with the communication unit 206, ASIC, DSP, FPGA, and the like of the control unit 202 in each communication apparatus. The functional units described in FIG. 3 will be mentioned as the subject when it is desired to clarify the entity that performs the processing.

In step S401, the control unit 202 of the AP 101 determines whether there is data to be transmitted to a connected STA such as the STA 102 and the STA 103. If the control unit 202 of the AP 101 determines that there is data to be transmitted to a connected STA such as the STA 102 and the STA 103 (YES in step S401), the processing proceeds to step S402. On the other hand, if the control unit 202 determines that there is no data to be transmitted to a connected STA such as the STA 102 and the STA 103 (NO in step S401), the processing proceeds to step S401 and the control unit 202 stands by for the occurrence of transmission data. If the control unit 202 determines that there is data to be transmitted, the control unit 202 also identifies at this timing the STA to serve as the main transmission destination in the subsequent transmission processing, and determines that STA as the main transmission destination.

In step S402, the control unit 202 attempts to acquire a transmission opportunity by checking whether the channel is in an idle state during a collision avoidance wait time that is determined at random. If the channel is confirmed to be idle during the collision avoidance wait time, the control unit 202 determines that a transmission opportunity for the AP 101 is successfully acquired. If the control unit 202 determines that a transmission opportunity for the AP 101 is successfully acquired (YES in step S402), the processing proceeds to step S403. On the other hand, if the operation channel is busy, or if another communication apparatus acquires a transmission opportunity and starts data transmission to make the operation channel busy during the wait time of the AP 101, the control unit 202 determines that a transmission opportunity is not successfully acquired. If a transmission opportunity is determined to not be successfully acquired (NO in step S402), the processing proceeds to step S402. The control unit 202 waits until the channel becomes idle, and attempts to acquire a transmission opportunity again.

In step S403, the control unit 202 determines a Transmission Opportunity (TXOP) based on the amount of data to be transmitted to the STA such as the STA 102, and generates a PHY preamble to transmit data for the duration of the determined TXOP. The TXOP represents the channel occupancy time. The control unit 202 then transmits the signal corresponding to the PHY preamble to the outside in cooperation with the communication unit 206 and the antennas 207. Here, the AP 101 generates a PHY preamble including information indicating that an interrupt by a low-latency data MAC frame may occur. If the transmission data about to be transmitted to a destination is determined to be data of high urgency itself, the control unit 202 may generate a PHY preamble that does not indicate that an interrupt by a low-latency data MAC frame may occur. In such a case, the AP 101 may generate and transmit a normal A-MPDU in which a plurality of MAC frames destined for one destination is bundled. In such a manner, when data of high urgency is about to be transmitted, a conventional A-MPDU destined for one destination with no interrupt taken into account can be transmitted without performing the interrupt control to be described below.

Returning to the description of FIG. 4, the case of performing control with interrupts taken into account will now be described. In step S404, the low-delay frame control unit 304 determines whether data destined for a destination other than the main transmission destination has been stored and/or is newly stored as data to be transmitted. If transmission data destined for a destination other than the main transmission destination is determined to have been stored and/or be newly stored as data to be transmitted (YES in step S404), the processing proceeds to step S405.

On the other hand, if no transmission data destined for another destination is determined to be stored as data to be stored (NO in step S404), the processing proceeds to step S407.

In step S405, the low-delay frame control unit 304 determines whether the type of the foregoing data destined for another destination is data of high urgency such as low-latency data. If the type of the data is determined to be data of high urgency such as low-latency data (YES in step S405), the processing proceeds to step S406. If the type of the data is determined to not be data of high urgency such as low-latency data (NO in step S405), the processing proceeds to step S407.

Satisfying the condition that transmission data destined for another destination is stored and the condition that the type of the transmission data is data of high urgency such as low-latency data is an example of satisfying a specific condition.

Next, data generation and transmission control will be described with reference to steps S406 to S408. Note that the processing of steps S406 to S408 actually is asynchronously performed through the interconnection of the functional units 301 to 304.

The generation and transmission of data frames for the main transmission destination will initially be described. In step S407, the MAC frame generation unit 301 sequentially generates MAC frames containing data to be transmitted to the main transmission destination. In step S408, the aggregation control unit 302 manages the MAC frames that are generated by the MAC frame generation unit 301 and ready for transmission, and schedules transmission order. Based on the scheduled transmission order, the aggregation control unit 302 transmits signals corresponding to the MAC frames generated by the foregoing control to the outside as a part of the A-MPDU in cooperation with the wireless communication control unit 303, the communication unit 206, and the antennas 207. The communication unit 206 controls the antennas 207 so that the signals are nondirectionally transmitted.

Meanwhile, in step S406, the control unit 202 generates MAC frames containing the low-latency data in cooperation with the MAC frame generation unit 301. Specifically, the low-delay frame control unit 304 identifies the destination of the low-latency data. The low-delay frame control unit 304 then transmits an interrupt instruction including information specifying the MAC address indicating the destination of the low-latency data and the storage address of the interrupting data to the MAC frame generation unit 301. Receiving the interrupt instruction, the MAC frame generation unit 301 generates one or more MAC frames containing the low-latency data based on the interrupt instruction. With the low-latency data MAC frames generated, the MAC frame generation unit 301 transmits information about the MAC frames and an instruction that triggers rescheduling of the transmission order to the aggregation control unit 302.

Receiving the information and the instruction that triggers rescheduling, the aggregation control unit 302 operating asynchronously with the MAC frame generation unit 301 reschedules the group of frames scheduled for transmission so that the interrupt frames are preferentially transmitted. Once the rescheduling is performed, the aggregation control unit 302 further notifies the wireless communication control unit 303 of transmission instructions and the data order so that the MAC frames are transmitted in the rescheduled order. As a result, in step S408, the signals corresponding to the group of frames are transmitted in the rescheduled order. If rescheduling is not performed, in step S408, the aggregation control unit 302 notifies the wireless communication control unit 303 of transmission instructions and the data order so that the MAC frames are transmitted in order based on the original schedule as appropriate. The wireless communication control unit 303 notified of the transmission instructions and the data order transmits the signals corresponding to the MAC frames generated in step S406 or step S407 to the outside in cooperation with the communication unit 206 and the antennas 207.

In step S409, the control unit 202 determines whether there remains any of the acquired TXOP. If any of the acquired TXOP is determined to remain (YES in step S409), the processing proceeds to step S410. If none of the acquired TXOP is determined to remain (NO in step S409), the processing proceeds to step S411.

In step S410, the control unit 202 determines whether there is data be transmitted. If the control unit 202 determines that there is data to be transmitted (YES in step S410), the processing proceeds to step S404 and the control unit 202 continues the generation and transmission processing of the subsequent MAC frames. If the control unit 202 determines that there is no data to be transmitted (NO in step S410), the processing proceeds to step S411. In step S411, the MAC frame generation unit 301 generates a MAC frame corresponding to the foregoing Trigger frame, and transmits the signal corresponding to the generated MAC frame to the outside in cooperation with various units, whereby the transmission of the A-MPDU is completed (transmission end processing). Through the series of controls described above, in a state where A-MPDU frames for communicating data destined for one destination are being transmitted or prepared for transmission, data destined for another destination can be transmitted by interrupting the A-MPDU.

Next, data reception control by an STA such as the STA 102 and the STA 103 will be described with reference to FIG. 5.

In step S501, the control unit 202 of the STA analyzes the preamble of a received PPDU and compares the BSS color value stored in the BSS Color field 711 of the preamble with the BSS color value of the network to which the STA belongs, to determine whether the BSS color values are the same. If the comparison result indicates that the BSS color values are the same, the control unit 202 determines that a PPDU specifying the BSS color value of the network to which the STA belongs is received (YES in step S501), and the processing proceeds to step S502. If the comparison result indicates that the BSS color values are different, the control unit 202 determines that a PPDU specifying the BSS color value of the network to which the STA belongs is not received (NO in step S501), and the processing proceeds to step S501. Here, the control unit 202 stands by for the reception of a PPDU specifying the BSS color value of the network to which the STA belongs. During the transmission period of the PPDU destined for another BSS, the control unit 202 may set a Network Allocation Vector (NAV). The NAV means a transmission prohibition period.

In step S502, the control unit 202 analyzes the preamble of the received PPDU and determines whether a data interrupt is suggested. Specifically, if the preamble includes information indicating that an interrupt by a low-latency data MAC frame may occur, the control unit 202 determines that a data interrupt is suggested (YES in step S502), and the processing proceeds to step S503. On the other hand, if the preamble includes information indicating that an interrupt by a low-latency data MAC frame will not occur, or the preamble does not include information indicating whether an interrupt may occur, the control unit 202 determines that a data interrupt is not suggested (NO in step S502), and the processing proceeds to step S516. The determination can be made, for example, based on whether the value of the LL Data Preemption Suggestion field 712 of the PHY preamble illustrated in FIG. 7 is “1”. As a modification, the determination may be made based on whether the value of the PPDU Type And Compression Mode field 713 described above is “3”. Alternatively, the determination may be made based on whether the value of the STA-ID field 716 is the foregoing special value “0”.

Next, control in the case where an interrupt is not suggested will be described. In step S516, the wireless communication control unit 303 and the interpretation unit 305 cooperatively interpret the preamble included at the beginning of the received PPDU or the first MAC frame, and determine whether the MAC frame is destined for the STA. Specifically, if the STA-ID of the STA is stored in the STA-ID field of the preamble, the MAC frame is determined to be destined for the STA. If a group ID to which the STA belongs or an ID that indicates broadcasting is stored, the wireless communication control unit 303 and the interpretation unit 305 further refer to the value of the Address field 721 included in the MAC Header field 702, and determine whether the MAC frame is destined for the STA. If the MAC frame is determined to be destined for the STA (YES in step S516), the processing proceeds to step S517. On the other hand, if the MAC frame is determined to not be destined for the STA(NO in step S516), the processing proceeds to step S518.

In step S517, the wireless communication control unit 303 and the interpretation unit 305 cooperatively decode all the MAC frames included in the received PPDU. The interpretation unit 305 provides the data obtained as a result of decoding to upper layers, or performs communication control in cooperation with various units based on the decoding result. Once the decoding of the received PPDU is completed, the processing proceeds to step S519. In step S518, the control unit 202 sets the NAV while the PPDU not destined for the STA is transmitted. The control unit 202 may control the pieces of hardware constituting the STA to transition to a power save mode for reduced power consumption.

Next, control in the case where an interrupt is suggested will be described. In step S503, the wireless communication control unit 303 and the interpretation unit 305 cooperatively determine whether the first MAC frame is destined for the STA. The determination criterion is similar to that used when determining whether the MAC frame is destined for the STA, described in step S516. If the first MAC frame is determined to be destined for the STA (YES in step S503), the processing proceeds to step S511. If the first MAC frame is determined to not be destined for the STA (NO in step S503), the processing proceeds to step S504.

Next, the control of decode processing and discard processing by the STA to be interrupted when a PPDU suggesting interrupt control is received will be described.

In step S511, the wireless communication control unit 303 and the interpretation unit 305 cooperatively interpret the MAC frame and determine whether the MAC frame is destined for the STA. If the MAC frame is determined to be destined for the STA (YES in step S511), the processing proceeds to step S512. In step S512, the interpretation unit 305 decodes the Frame Body of the MAC frame. If the MAC frame is determined to not be destined for the STA (NO in step S511), the processing proceeds to step S513, in which case the interpretation unit 305 discards the MAC frame without interpreting the Frame Body. Once the decode processing and interpretation process of the one MAC frame is completed, the processing proceeds to step S513.

In step S513, the wireless communication control unit 303 and the interpretation unit 305 determine whether the end of the PPDU is reached. If the end of the PPDU is determined to be reached (YES in step S513), the processing proceeds to step S519.

On the other hand, if the end of the PPDU is determined to not be reached (NO in step S513), the processing proceeds to step S511. The wireless communication control unit 303 and the interpretation unit 305 determine the destination of the next MAC frame and perform the decode processing or discard processing based on the determination result.

Finally, the control of the decode processing and discard processing by the STA to not be interrupted in the case where a PPDU suggesting interrupt control is received will be described.

In step S504, the control unit 202 determines whether the STA is in a standby state of waiting for an interrupt by a frame containing low-latency data. If the control unit 202 determines that the STA is in the standby state (YES in step S504), the processing proceeds to step S505. If the control unit 202 determines that the STA is not in the standby state (NO in step S504), the processing proceeds to step S509. In step S504, whether to wait for an interrupt frame may be switched depending on whether the value indicating the Group ID to which the STA belongs is stored in the PHY preamble, in addition to whether the STA is in the standby state. More specifically, if the PPDU is determined to be destined for a Group ID to which the STA does not belong, the STA may perform the processing of step S509 without waiting for reception. In step S509, the control unit 202 performs NAV setting processing similar to that described in step S518, and optionally performs transition processing to the power save mode.

On the other hand, in steps S505 to S507, the wireless communication control unit 303 and the interpretation unit 305 repeat decode processing, discard processing, and check processing as to whether the end of the PPDU is reached, similar to those of the foregoing steps S511 to S513. Through such processing, the STA waiting for an interrupt frame can decode only interrupt MAC frames destined for itself and obtain low-latency data destined for itself.

In step S519, the control unit 202 transmits an Ack frame to the AP 101 to notify of the reception of MAC frames that are successfully decoded. Specifically, the STA 102 and the STA 103 receiving an A-MPDU respond with an Ack or a Block Ack based on the decoding of the Trigger frame. Alternatively, the STAs may be configured to not respond to interrupt frames with an Ack. In such a case, the foregoing exchange of the Trigger frame at the end of the A-MPDU can be omitted. Alternatively, the attachment of the Trigger frame to the end of the A-MPDU may be omitted. In such a case, to receive a Block Ack, the AP 101 is configured to transmit a Multi-User Block Ack Request (MU-BAR) again. Here, the AP 101 receives Block Ack frames from the STAs 102 and 103 as a response to the MU-BAR frame.

When transmitting a Block Ack, the STA performs scoring of the sequence numbers of the respective MAC frames, and transmits a bitmap with the bits corresponding to the sequence numbers of received and decoded MAC frames as “1”. The AP 101 according to the present embodiment manages a series of sequence numbers of MAC frames destination by destination. In other words, if MAC frames destined for another device are inserted at some point, a series of sequence numbers different from that used for the communication with the main transmission destination is assigned to the inserted MAC frames. Even when the STA to be interrupted and the STA to interrupt transmit a Block Ack, Block Acks based on the respective series of sequence numbers can thus be transmitted.

The foregoing procedure enables insertion of MAC frames destined for another STA in the middle of an A-MPDU for a given STA. Interrupt frames can thus be transmitted without being affected by the overhead needed to acquire transmission rights or the overhead of the PHY preamble.

### Second Embodiment

In the first embodiment, a case is exemplified in which STAs having the capability to receive low-latency data interrupts stand by for interrupt reception. In a second embodiment, in addition to the control described in the first embodiment, an AP and STAs negotiate in advance as to whether low-latency data reception is intended.

The STAs are configured to, if having negotiated in advance about their intention to receive low-latency data, stand by for an interrupt. The hardware configuration and software configuration of the communication apparatuses are similar to those described in the first embodiment. A description thereof will thus be omitted.

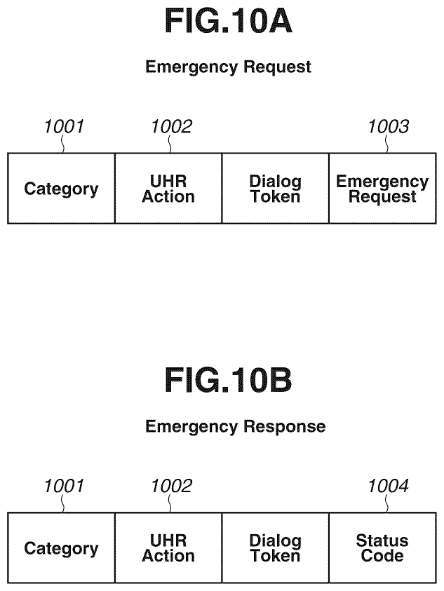

Frames used in the negotiation will now be described with reference to FIGS. 10A and 10B. FIG. 10A illustrates an example of an Emergency Request Action frame that an STA transmits to the AP. FIG. 10B illustrates an example of an Emergency Response Action frame that the AP transmits to the STA.

An STA (hereinafter, STA 103) intended to stand by for low-latency interrupt frame reception transmits the Emergency Request Action frame illustrated in FIG. 10A to the AP 101. This frame includes a Category field 1001, a UHR Action field 1002, and an Emergency Request field 1003.

The Category field 1001 is a field indicating that the Emergency Request Action frame is a UHR Action frame. For example, “38” is stored as the value of the Category field 1001.

The UHR Action field 1002 stores the type of Action frame. For example, to indicate that this frame requests data reception using the low-latency data interrupt scheme, “0” is stored as the value of the UHR Action field 1002.

The Emergency Request field 1003 stores information indicating whether the STA 103 is intended to transition to a state of standing by for low-latency data interrupt frame reception or to a non-standby state. For example, storing “1” in this field indicates that the STA 103 is intended to transition to the state of standing by for low-latency data interrupt frame reception. Storing “0” in this field indicates that the STA 103 is intended to transition to the state of not standing by for low-latency data interrupt frame reception.

Receiving the Emergency Request Action frame illustrated in FIG. 10A, the AP 101 transmits an Emergency Response Action frame illustrated in FIG. 10B as a response. This frame includes a Category field 1001, a UHR Action field 1002, and a Status Code field 1004. The value stored in the Category field 1001 is the same as with the Emergency Request Action frame. To indicate that this frame is an Emergency Response Action frame, “1” is stored in the UHR Action field 1002, for example.

The Status Code field 1004 indicates whether to accept the request from the STA 103. For example, if the request is accepted, the AP 101 stores “0” as the value of the Status Code field 1004. If the request is unacceptable due to some reason, a value other than “0” is stored in the Status Code field 1004. Receiving the Emergency Response Action frame, the STA 103 transitions to the state of standing by for a low-delay frame or the state of not standing by for a low-delay frame, based on the value of the Status Code field 1004.

The STA 103 intended to receive data using the low-latency data interrupt scheme performs such prior negotiations at timing before step S807 of FIG. 8.

While in the present embodiment, the STA 103 transmits the request to the AP 101, the negotiation direction may be reversed. In other words, a modification can be made so that the AP 101 transmits a request to its associated STAs and the associated STAs transmit responses. By performing the control described in the second embodiment, STAs can declare to the AP 101 that they will not stand by for interrupt frame reception, in cases such as when the remaining battery level is low and the power consumption is desirably reduced, and when power saving mode is set by user setting.

The low-delay frame control unit 304 of the AP 101 having made the negotiations manages state information indicating whether the STAs standby for low-latency data interrupt frame reception, in association with information about the STAs.

This state information can be used to identify whether the STAs are capable of frame interrupt reception described in steps S404 to S406 of FIG. 4. Here, the AP 101 may perform control to assume an STA linked with state information indicating the state of standing by for low-latency data interrupt frame reception as one capable of interrupt reception. In other words, even when low-latency data to be transmitted to an STA linked with state information indicating a non-standby state occurs, an interrupt for that STA can be omitted.

### First Modification

The foregoing embodiments have been described by using a case where one MAC frame destined for the STA 103 is included in the A-MPDU from the AP 101 to the STA 102. It will be understood, however, that this is not restrictive. For example, interrupt frames for two or more different STAs may be bundled into the A-MPDU in addition to the MAC frames for the main destination STA. MAC frames for the same destination with different Traffic Identifiers (TIDs) or Access Categories (ACs) and different sequence numbers may be bundled. A plurality of interrupt MAC frames may be destined for a specific STA.

The interrupt technique described in the embodiment described above can also be applied to the transmission of an A-MPDU that an STA transmits to the AP 101. In such a case, the STA can transmit MAC frames containing low-latency data to be transmitted to another STA by interrupting the A-MPDU with which the STA is transmitting data to the AP 101.

### Second Modification

In the first embodiment, the Extended Capabilities Element 600 illustrated in FIG. 6 is described to indicate capability information in one bit. However, the Extended Capabilities Element 600 may be modified for more detailed capability notification. Specifically, the Extended Capabilities Element 600 may be configured so that the presence or absence of a first capability to support to-be-interrupted reception and the presence or absence of a second capability to support interrupt reception are indicated using different bits. In such a case, the first capability indicates the presence or absence of the capability to support the to-be-interrupted reception, which involves receiving as the main destination an A-MPDU including interrupt frames, appropriately discarding the interrupt frames, and receiving the frames destined for itself. Meanwhile, the second capability may indicate the presence or absence of the capability to support interrupt reception, which involves sniffing the A-MPDU transmitted to another, main transmission destination, and appropriately receiving the interrupt frames destined for itself. In such a case, the AP 101 links up and manages these detailed capabilities as information about the connected STAs. The information is then used for selection of the main destination to be interrupted and selection of the interrupting destination.

### Third Modification

In the first embodiment, the PHY preamble is configured to notify information indicating whether a data interrupt is suggested. However, the PHY preamble may be configured with this notification omitted. In such a case, the STA in the standby state of standing by for an interrupt frame interprets the entire PPDU data portion received from the AP 101. The STA can then determine whether MAC frames destined for itself are included, and select and decode the MAC frames destined for itself.

### Fourth Modification

In the first embodiment, that an interrupt may occur in the PPDU is described to be indicated by setting “3” in the PPDU Type And Compression Mode field 713. Here, a modification may be made so that the STA to stand by for reception is explicitly identified by the AP 101 and notified using the PHY preamble.

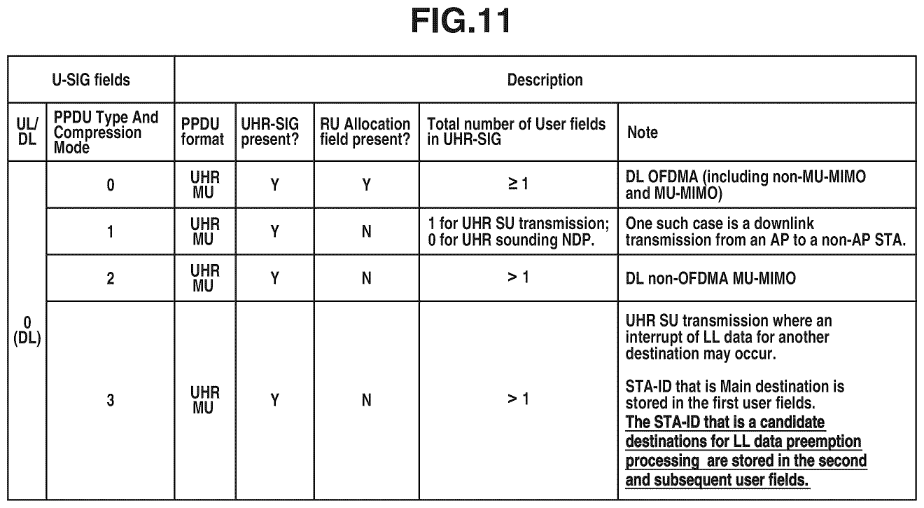

This modification will be described with reference to FIG. 11. FIG. 11 is a diagram for describing field values stored in the U-SIG of the PHY preamble and PPDU characteristics when such field values are set. FIG. 11 illustrates an excerpt of the DL scenario as an example. The PPDU characteristics when “0” is set in the UL/DL field 710 and “0” to “2” are set in the PPDU Type And Compression Mode field 713 are similar to those of an Extremely High Throughput (EHT) PPDU. Setting “0” in the PPDU Type And Compression Mode field 713 of a DL PPDU means that the PPDU is one for DL OFDMA (MU-MIMO technique is also applicable). In such a case, the UHR-SIG can include an RU allocation field for implementing OFDMA, and one or more user fields. Setting “1” in the PPDU Type And Compression Mode field 713 of a DL PPDU means that the PPDU is one for performing single-user communication or one for sounding. In such a case, the UHR-SIG omits the RU allocation field for implementing OFDMA. Moreover, one user field may or may not be included. Setting “2” in the PPDU Type And Compression Mode field 713 of a DL PPDU means that this PPDU is a non-OFDMA MU-MIMO PPDU. In such a case, the UHR-SIG omits the RU allocation field for implementing OFDMA. Moreover, two or more user fields are included to specify two or more terminals as MU-MIMO targets.

In this modification, setting “3” in the PPDU Type And Compression Mode field 713 of a DL PPDU defines a PPDU for single-user communication where an interrupt may occur. In such a case, the UHR-SIG omits the RU allocation field for implementing OFDMA. Moreover, two or more user fields are included in the UHR-SIG.

Here, the first user field in the U-SIG is configured to store the STA-ID of the main transmission destination to be interrupted. The second and subsequent user fields are configured to store the STA-IDs of candidate reception destinations to stand by for interrupt frame reception.

Control in the case where this modification is applied will be briefly described. The AP 101 estimates an STA for which the probability of occurrence of low-latency data is high, based on time-series data such as past communication records of respective STAs, communication parameters for the STAs, etc. A trained machine learning model obtained by pre-training may be used for this estimation. When generating the PHY preamble in step S403, the AP 101 then generates a PHY preamble that contains the STA-ID of one or more STAs for which the probability of occurrence of low-latency data is estimated to be high in the second and subsequent user fields. Such processing enables the PHY preamble to explicitly present the STA(s) to stand by for reception. Meanwhile, in step S502, STAs such as the STA 102 and the STA 103 analyze the PHY preamble of the received PPDU, and determine whether an interrupt is suggested. Specifically, if “0” is set in the UL/DL field 710 and “3” is set in the PPDU Type And Compression Mode field 313, the STAs determine that an interrupt is suggested.

Instead of the reception determination in steps S503 and S504, which is performed after the determination that an interrupt is suggested, each STA also performs the following reception determination. The STA initially determines whether its own STA-ID is specified in the first user field of the U-SIG. If its own STA-ID is determined to be specified in the first user field of the U-SIG, the processing proceeds to step S511. If its own STA-ID is determined to not be specified in the first user field of the U-SIG, the processing proceeds to the determination of whether interrupt reception standby is needed. The STA determines whether interrupt reception standby is needed, based on whether its own STA-ID is specified in the second or subsequent user field of the UHR-SIG. If its own STA-ID is specified in the second or subsequent user field of the UHR-SIG, the STA determines that interrupt reception standby is needed, and the processing proceeds to step S505. On the other hand, if its own STA-ID is not specified in the second or subsequent user field of the UHR-SIG, the STA determines that interrupt reception standby is not needed, and the processing proceeds to step S509. Such a modification enables frame interrupt control with explicit identification of STAs to stand by for low-latency data reception.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure is not limited to the foregoing embodiments, and various modifications and changes can be made without departing from the spirit and scope of the disclosure. The claims are therefore appended to make the scope of the disclosure public.

According to an aspect of the present disclosure, data can be transmitted to another destination while wireless frames for communicating data destined for a given destination are being transmitted.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus comprising:
at least one memory that stores a set of instructions; and
at least one processor that executes the instructions, the instructions, when executed, causing the communication apparatus to perform operations comprising:
performing control to generate an Aggregated media access control (MAC) Protocol Data Unit (A-MPDU) in which a plurality of MAC frames each including a MAC header and payload is bundled and to transmit the generated A-MPDU,
wherein the communication apparatus is configured to, in a case where a specific condition is satisfied, perform control to transmit an A-MPDU in which a plurality of MAC frames destined for a plurality of different destinations is bundled, the plurality of MAC frames including at least a first MAC frame destined for a first destination and a second MAC frame destined for a second destination.

2. The communication apparatus according to claim 1, wherein a preamble of the A-MPDU including the first and second MAC frames includes information indicating that different MAC frames destined for a plurality of destinations is bundled in the A-MPDU.

3. The communication apparatus according to claim 1, the operations further comprising:
determining a Modulation and Coding Scheme (MCS) of a data portion in a case where the A-MPDU in which the first MAC frame destined for the first destination and the second MAC frame destined for the second destination are bundled is transmitted.

4. The communication apparatus according to claim 1,
wherein the communication apparatus is an access point apparatus,
wherein the operations further comprises managing one or more station apparatuses connected to the access point apparatus,
wherein, in the managing, the communication apparatus manages the one or more connected station apparatuses, each being distinguished based on a presence or absence of a capability of a corresponding station apparatus to accept low-latency data interrupt reception,
wherein the specific condition is that low-latency data for a station apparatus having the capability is stored, and
wherein the communication apparatus is configured to, in a case where the low-latency data is stored, transmit an A-MPDU in which a plurality of MAC frames destined for a plurality of different destinations is bundled, by performing control to perform interrupt transmission of a MAC frame destined for the station apparatus having the capability and configured to transmit the stored low-latency data, the interrupt transmission including interrupting an A-MPDU where MAC frames destined for another station apparatus are being transmitted or prepared for transmission.

5. A communication apparatus comprising:
at least one memory that stores a set of instructions; and
at least one processor that executes the instructions, the instructions, when executed, causing the communication apparatus to perform operations comprising:
performing control to receive an Aggregated media access control (MAC) Protocol Data Unit (A-MPDU); and
determining whether a MAC frame constituting the A-MPDU is destined for the communication apparatus, and, in a case where the MAC frame is determined to be destined for the communication apparatus, decoding and interpreting the MAC frame determined to be destined for the communication apparatus,
wherein, in the interpreting, the communication apparatus performs control to exclude, from a target of decoding, a frame body of a MAC frame, among MAC frames constituting the A-MPDU, the MAC frame being determined to be destined for a communication apparatus different from the communication apparatus.

6. The communication apparatus according to claim 5, wherein excluding the frame body of the MAC frame determined to be destined for the another communication apparatus from the target of decoding is controlled by discarding the frame body without decoding.

7. A method for controlling a communication apparatus, comprising
performing transmission control to generate an Aggregated media access control (MAC) Protocol Data Unit (A-MPDU) in which a plurality of MAC frames each including a MAC header and payload is bundled and to transmit the generated A-MPDU,
wherein, in a case where a specific condition is satisfied, the transmission control is performed to transmit an A-MPDU in which a plurality of MAC frames destined for a plurality of different destinations is bundled, the plurality of MAC frames including at least a first MAC frame destined for a first destination and a second MAC frame destined for a second destination.

8. A method for controlling a communication apparatus, comprising:
receiving an Aggregated media access control (MAC) Protocol Data Unit (A-MPDU); and
determining whether a MAC frame constituting the A-MPDU is destined for the communication apparatus, and in a case where the MAC frame is determined to be destined for the communication apparatus, decoding and interpreting the MAC frame determined to be destined for the communication apparatus,
wherein, in the interpreting, a frame body of a MAC frame, among MAC frames constituting the A-MPDU, is excluded from a target of decoding, the MAC frame being determined to be destined for a communication apparatus different from the communication apparatus.

9. A non-transitory computer-readable storage medium that stores a program that causes, when the program is executed, a communication apparatus to perform:
transmission control to generate an Aggregated media access control (MAC) Protocol Data Unit (A-MPDU) in which a plurality of MAC frames each including a MAC header and payload is bundled and to transmit the generated A-MPDU,
wherein, in a case where a specific condition is satisfied, the transmission control is performed to transmit an A-MPDU in which a plurality of MAC frames destined for a plurality of different destinations is bundled, the plurality of MAC frames including at least a first MAC frame destined for a first destination and a second MAC frame destined for a second destination.

10. A non-transitory computer-readable storage medium that stores a program that causes, when the program is executed, a communication apparatus to:
receive an Aggregated media access control (MAC) Protocol Data Unit (A-MPDU); and
determine whether a MAC frame constituting the A-MPDU is destined for the communication apparatus, and in a case where the MAC frame is determined to be destined for the communication apparatus, decoding and interpreting the MAC frame determined to be destined for the communication apparatus,
wherein, in the interpreting, a frame body of a MAC frame, among MAC frames constituting the A-MPDU, is excluded from a target of decoding, the MAC frame being determined to be destined for a communication apparatus different from the communication apparatus.
